(19) United States
(12) Patent Application Publication
(10) Pub. No.: US 2010/0311852 A1
(43) Pub. Date: Dec. 9, 2010

(54) PREPARING METHOD FOR MELAMINE-FORMALDEHYDE SPHERES

(75) Inventors: JEUNG-KU KANG, Daejeon (KR); SE-YUN KIM, Daejeon (KR); JUNG-HOON CHOI, Daejeon (KR); JUN-HO KWON, Daejeon (KR)

Correspondence Address: WPAT, PC;INTELLECTUAL PROPERTY ATTORNEYS, 2030 MAIN STREET, SUITE 1300, IRVINE, CA, 92614, US

(73) Assignee: KOREA ADVANCED INSTITUTE OF SCIENCE AND TECHNOLOGY, Daejeon (KR)

(21) Appl. No.: 12/626,695

(22) Filed: Nov. 27, 2009

(30) Foreign Application Priority Data
Jun. 4, 2009 (KR) 10-2009-0049623

(51) Int. Cl. C08G 14/10; C08J 9/36

(52) U.S. Cl. 521/77; 528/232

(57) ABSTRACT

Disclosed is a preparing method for melamine-formaldehyde spheres (MFSs). The preparing method for MFS according to the present invention comprises mixing melamine in an aqueous formaldehyde solution and heating the solution to prepare a melamine-formaldehyde resin; admixing the melamine-formaldehyde resin with a surfactant, agitating the mixture, and centrifuging the mixture to prepare a solid powder; and washing the solid powder with an aqueous ethanol solution and drying the wetted solid powder to obtain the melamine-formaldehyde sphere. Regulating agitation speed of a mixture may control a size of the melamine-formaldehyde sphere.

The preparing method for MFS according to the present invention may further comprise carbonizing the melamine-formaldehyde sphere after obtaining the melamine-formaldehyde sphere. Controlling a temperature for carbonization may control an amount of pores contained in the melamine-formaldehyde sphere.

This application claims priority to Korean Patent Application No. 10-2009-0049623, filed on Jun. 4, 2009, in the Korean Intellectual Property Office, the entire contents of which are hereby incorporated by reference.

### BACKGROUND OF THE INVENTION

1. Field of the Invention

The present invention relates to a preparing method for melamine-formaldehyde spheres, capable of controlling a size of the spheres and/or an amount of pores contained in the spheres.

2. Description of the Related Art

As a porous material with nano-scale pores has relatively large surface area per unit weight, a great deal of studies and/or investigation into such porous material have been widely conducted in various applications including, for example, supporting of metal catalysts, surface adsorption of gaseous molecules, separation of gaseous molecules, and so forth.

Such porous material may be generally classified into three types, in terms of size of pore: a microporous material having pores of less than 2 nanometers; a mesoporous material having pores with a size of 2 to 50 nanometers; and a macroporous material having pores of more than 50 nanometers. The microporous material having small sized pores is useful for application of separation or storage of gas molecules and, especially in recent years, some documents and articles suggesting that carbon based materials having pores of not more than 1 nm are advantageous for storage of gas molecules have been disclosed.

Examples of the microporous materials under current study may include zeolite, metal organic framework (MOF), carbon based microporous materials, etc. Commonly, such carbon based microporous material may be prepared by a method comprising; filling pores of the microporous material with organic materials, wherein the microporous material is used as a template commonly consisting of inorganic materials such as zeolite, carbonizing the charged organic materials, and removing the template. As such, conventional preparing methods for microporous materials described above require a complicated process, because the methods comprise process to remove a template.

### SUMMARY OF THE INVENTION

Accordingly, it is an object of the present invention to provide a preparing method for a microporous melamine-formaldehyde sphere by a simple process.

Another object of the present invention is to provide a preparing method for a melamine-formaldehyde sphere, capable of controlling a size of the sphere and/or an amount of pores contained in the sphere.

In order to achieve the above purposes, the present invention provides a preparing method for a melamine-formaldehyde sphere having nano-scale pores, comprising: mixing melamine in an aqueous formaldehyde solution and heating the mixed solution to prepare a melamine-formaldehyde resin; admixing the melamine-formaldehyde resin with a surfactant, agitating the mixture and centrifuging the mixture to prepare a solid powder; and washing the solid powder with an aqueous ethanol solution and drying the wetted solid powder to obtain the melamine-formaldehyde sphere.

Preferably, the method of the present invention further comprises carbonizing the melamine-formaldehyde sphere after obtaining the melamine-formaldehyde sphere.

According to the inventive preparing method for a melamine-formaldehyde sphere, a speed of agitating the mixture and/or a temperature for carbonization may be regulated, thus controlling a size of the melamine-formaldehyde sphere and an amount of pores contained in the melamine-formaldehyde sphere.

Also, compared to conventional methods requiring process to remove a template, the inventive method only requires carbonization to prepare a microporous melamine-formaldehyde sphere, thereby considerably reducing production cost and time thereof.

### BRIEF DESCRIPTION OF THE DRAWINGS

These and other objects, features, aspects, and advantages of the present invention will be more fully described in the following detailed description of examples, taken in conjunction with the accompanying drawings. In the drawings:

FIG. 1 is a schematic view illustrating a process of preparing a melamine-formaldehyde sphere having nano-scale pores according to the present invention;

FIG. 2 is a SEM photograph showing a plurality of melamine-formaldehyde spheres prepared according to Preparative Example;

FIG. 3 is an enlarged SEM photograph showing in detail one of the melamine-formaldehyde spheres prepared according to the Preparative Example;

FIG. 4 is a TEM photograph showing a plurality of the melamine-formaldehyde spheres prepared according to the Preparative Example;

FIG. 5 is an enlarged TEM photograph showing in detail one of the melamine-formaldehyde spheres prepared according to the Preparative Example;

FIG. 6 is a SEM photograph showing melamine-formaldehyde spheres prepared by a heating process without agitation according to Example 1;

FIG. 7 is a SEM photograph showing melamine-formaldehyde spheres prepared by a heating process with agitation at 100 rpm according to Example 1;

FIG. 8 is a SEM photograph showing melamine-formaldehyde spheres prepared by a heating process with agitation at 200 rpm according to Example 1;

FIG. 9 is a SEM photograph showing melamine-formaldehyde spheres prepared by a heating process with agitation at 600 rpm according to Example 1; and

FIG. 10 is a TEM photograph showing a melamine-formaldehyde sphere formed by carbonizing at a final temperature of 800° C. according to Example 2.

### DETAILED DESCRIPTION OF THE INVENTION

The present invention describes a preparing method for melamine-formaldehyde spheres (MFS). The preparing method for MFS according to the present invention comprises mixing melamine in an aqueous formaldehyde solution and heating the mixed solution to prepare a melamine-formaldehyde resin; admixing the melamine-formaldehyde resin with a surfactant, agitating the mixture, and centrifuging the mixture to prepare a solid powder; and washing the solid powder with an aqueous ethanol solution and drying the wetted powder to obtain the melamine-formaldehyde sphere.

The preparing method for MFS according to the present invention may further comprise carbonizing the melamine-formaldehyde sphere after obtaining the melamine-formaldehyde sphere.

In the preparing method for MFS according to the present invention, a size of the melamine-formaldehyde sphere may be increased when the speed of agitating the melamine-formaldehyde resin and the surfactant is higher during preparing the solid powder.

In the preparing method for MFS according to the present invention, the surfactant may be at least one selected from a group consisting of Pluronic F68, Pluronic F127, Pluronic P105 and Pluornic L44.

In the preparing method for MFS according to the present invention, an amount of pores contained in the melamine-formaldehyde sphere may be increased when a temperature for carbonization is higher during carbonizing the melamine-formaldehyde sphere.

Hereinafter, the present invention will be described in greater detail by the following preferred preparative example as well as examples. However, these examples are given for illustrative purposes and not intended to limit the scope of the present invention. Also, it will be understood by those skilled in the related art that various modifications and variations may be made within the technical idea of the present invention.

### EXAMPLE

### Preparative Example

### Melamine-formaldehyde Sphere Having Nano-Scale Pores

Referring to FIG. 1, a process of preparing melamine-formaldehyde spheres having nano-scale pores according to the present invention is described.

First, 8.924 mL of formaldehyde and 40 mL of water were poured in 250 mL round bottom flask to prepare an aqueous formaldehyde solution.

After adding 5.044 g of melamine and 0.2 mL of 1 M NaOH solution to the flask and admixing the same, the mixture was heated at 100° C. for 1 hour while agitating so as to obtain a transparent melamine-formaldehyde resin, followed by cooling the resin to room temperature.

Next, after dissolving 8 g of Pluronic F127 as a surfactant in 60 mL of water, the solution was mixed with the foregoing melamine-formaldehyde resin to prepare a mixture. Then, the mixture was agitated at room temperature for 6 hours to form a homogeneous mixture. Following this, the mixture was heated at 100° C. for 24 hours. During heating, Pluronic F127 completely surrounded the melamine-formaldehyde resin while the resin was subjected to condensation. The heated mixture was then cooled to room temperature, followed by centrifuging the same so as to obtain a white solid powder.

The solid powder was collected, and washed three times using an ethanol solution, which comprises ethanol and water in a ratio by volume of 1:1, and dried at 60° C. under vacuum, thus obtaining a melamine-formaldehyde sphere (MFS). In the forgoing processes, Pluronic F127 was separated from the melamine-formaldehyde resin, resulting in pores on a surface of the MFS.

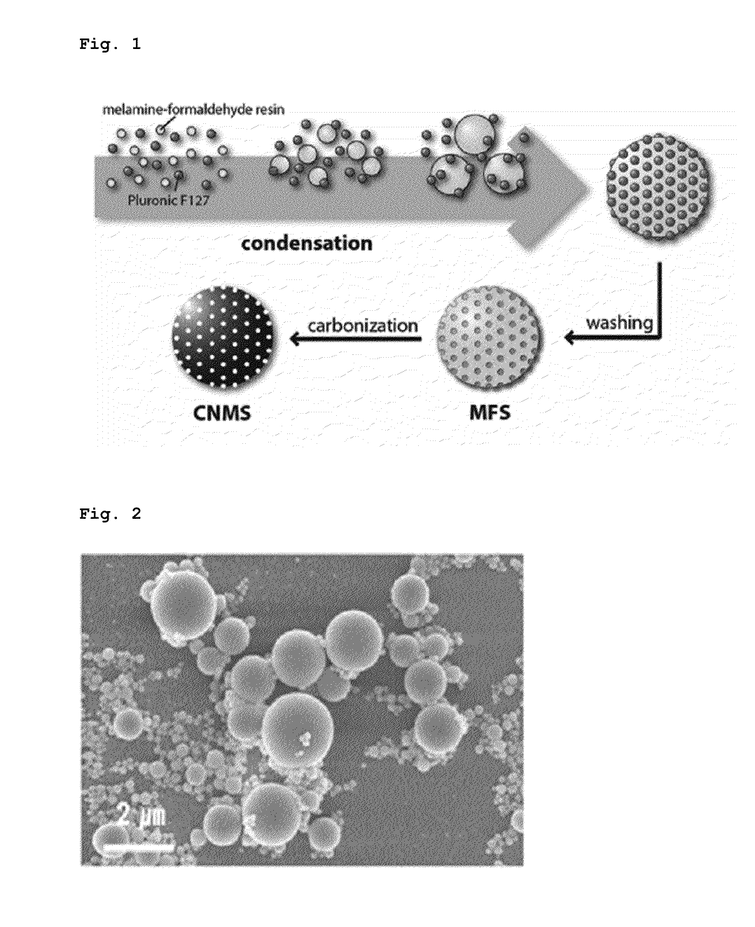

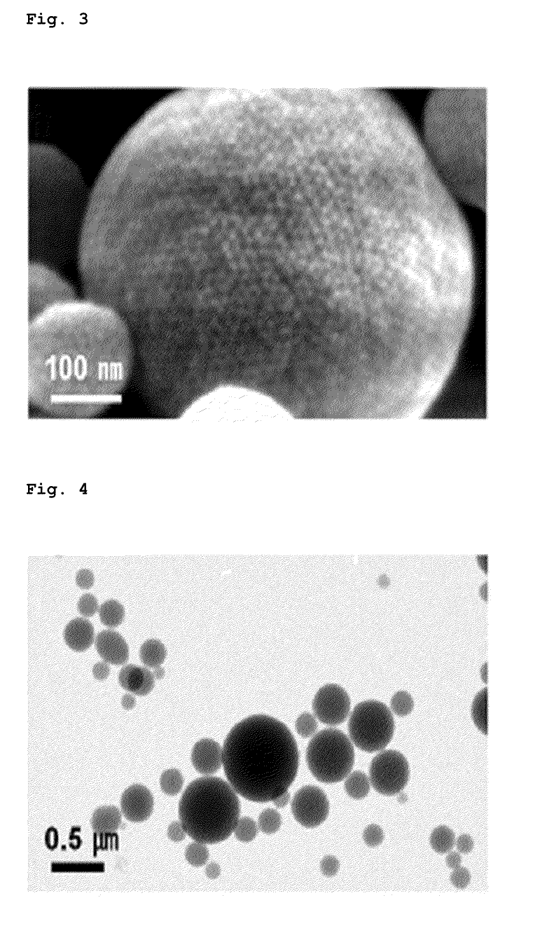

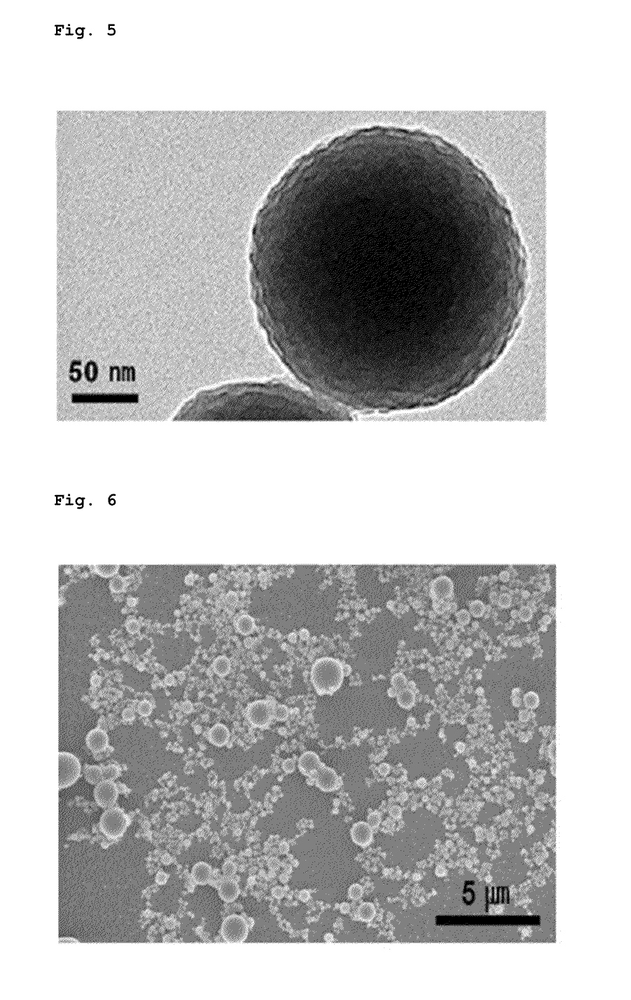

FIG. 2 is a SEM photograph showing a plurality of MFSs while FIG. 3 is an enlarged SEM photograph showing one of the MFSs. Similarly, FIG. 4 is a TEM photograph showing a plurality of MFSs while FIG. 5 is an enlarged TEM photograph showing one of the MFSs. As shown in FIG. 2 to FIG. 5, it can be seen that a MFS is spherical and, in particular, FIG. 3 showed that a pore formed on the surface of the MFS has a diameter of about 12 nm.

If the MFS is further subjected to carbonization, a MFS of carbon nitride microporous sphere (CNMS) may be obtained.

### Example 1

### Size of MFS Depending on Agitation Speed

In the present example, an experiment was performed to identify that a size of the MFS may be controlled by regulating agitation speed of the mixture, which comprises the melamine-formaldehyde resin and 8 g of Pluornic F127, while heating the mixture as described in the foregoing Preparative Example.

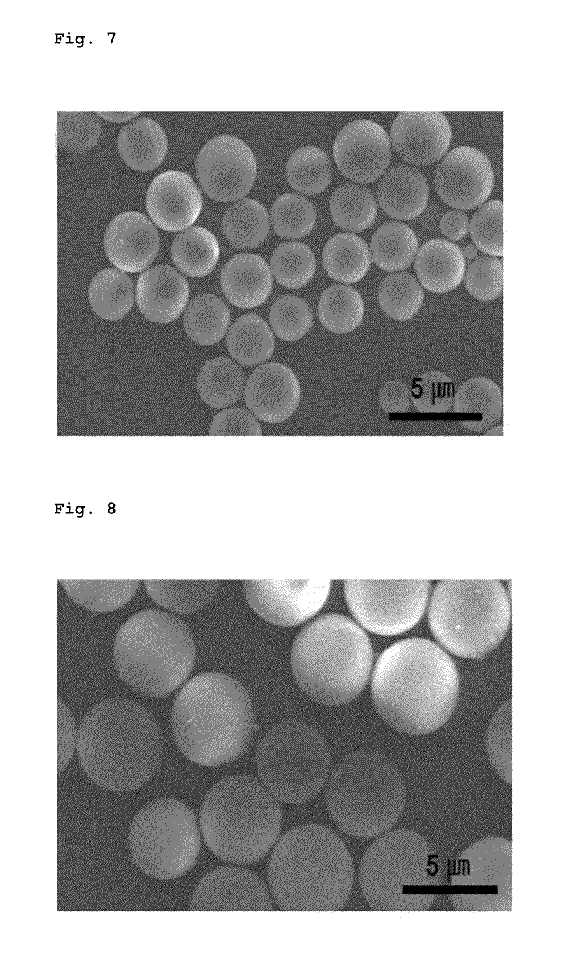

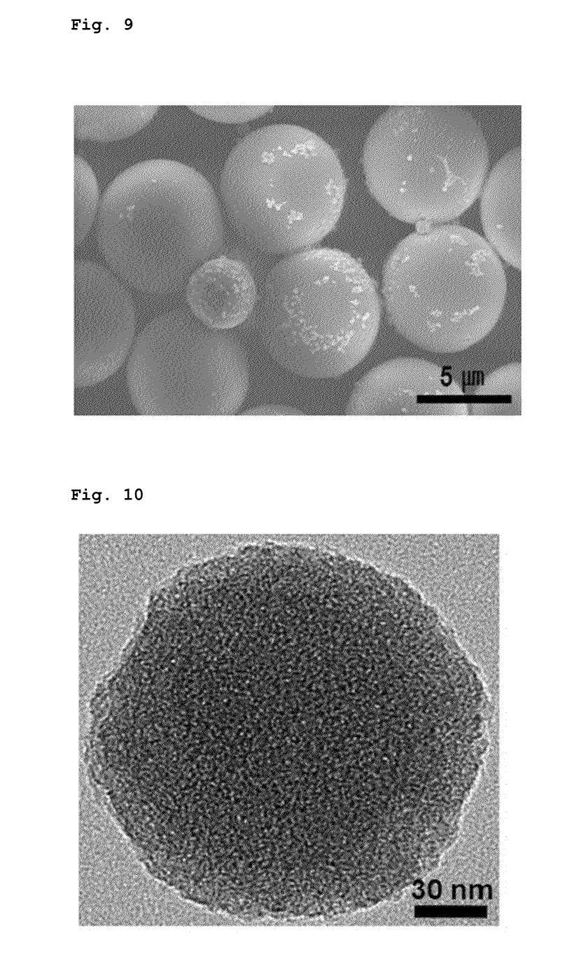

As for this experiment, FIG. 6 is a SEM photograph showing MFSs prepared by heating the mixture without agitation (A) and FIG. 7 is a SEM photograph showing MFSs prepared by heating the mixture with agitation at 100 rpm (B). Likewise, FIG. 8 is a SEM photograph showing MFSs prepared by heating the mixture with agitation at 200 rpm (C) and FIG. 9 is a SEM photograph showing MFSs prepared by heating the mixture with agitation at 600 rpm (D).

Comparing photographs between FIG. 6 to FIG. 9, it was found that the size of the MFS without agitation (A) was smallest and the size of the MFS with agitation at 600 rpm (D) was largest. From results of the foregoing experiment, it may be determined that a size of a melamine-formaldehyde sphere is increased by increasing the agitation speed of the mixture during heating.

### Example 2

### Amount of Pores Contained in MFS Depending on Temperature for Carbonization

In the present example, an experiment was performed to identify that an amount of pores contained in the MFS may be controlled by regulating a temperature for carbonization of the MFS as described in the foregoing Preparative Example.

As for this experiment, 1 g of MFSs was placed on an alumina boat and the alumina boat was placed in a tube furnace. Under an argon(Ar) gas flow atmosphere, the MFSs on the alumina boat was subjected to carbonization at a final temperature of 400° C. (A), 600° C. (B), and 800° C. (C), respectively. In this case, the temperature of the tube furnace was elevated to the final temperature by 1° C. per minute, provided that temperature is further maintained at 200° C. and 400° C. for 2 hours, respectively. Accordingly, micropores formed during carbonizing were not destroyed. As a result, MFSs of carbon nitride microporous sphere (CNMS) were obtained. A surface area per unit weight of one of the MFSs of CNMS was measured.

From measured results, it was found that the MFS with carbonization at the final temperature of 400° C. (A) has a surface area of 157 m²/g, while the MFS with carbonization at the final temperature of 600° C. (B) has a surface area of 319 m²/g. Similarly, the MFS with carbonization at the final temperature of 800° C. (C) has a surface area of 995 m²/g. The MFS (C) is shown in a TEM photograph of FIG. 10, wherein red parts indicate pores having a diameter of about 1 nm.

As is apparent from the foregoing experimental results, the surface area per unit weight of the MFS is increased as the temperature for carbonization is elevated. This means that the MFS has an increased amount of pores.

Although the present invention has been described in detail with reference to its presently preferred embodiment, it will be understood by those skilled in the art that various modifications and equivalents can be made without departing from the spirit and scope of the present invention, as set forth in the appended claims. Also, the substances of each constituent explained in the specification can be easily selected and processed by those skilled in the art from the well-known various substances. Also, those skilled in the art can remove a part of the constituents as described in the specification without deterioration of performance or can add constituents for improving the performance. Furthermore, those skilled in the art can change the order to methodic steps explained in the specification according to environments of processes or equipments. Thus, it is intended that the present invention covers the modifications and variations of this invention provided they come within the scope of the appended claims and their equivalents.

What is claimed is:

1. A preparing method for a melamine-formaldehyde sphere having nano-scale pores, comprising:
mixing melamine in an aqueous formaldehyde solution and heating the mixed solution to prepare a melamine-formaldehyde resin;
admixing the melamine-formaldehyde resin with a surfactant, agitating the mixture, and centrifuging the mixture to prepare a solid powder; and
washing the solid powder with an aqueous ethanol solution and drying the wetted solid powder to obtain the melamine-formaldehyde sphere.

2. The method according to claim 1, further comprising: carbonizing the melamine-formaldehyde sphere after obtaining the melamine-formaldehyde sphere.

3. The method according to claim 1, wherein a size of the melamine-formaldehyde sphere is increased when the speed of agitating the melamine-formaldehyde resin and the surfactant is higher during preparing the solid powder.

4. The method according to claim 1, wherein the surfactant is at least one selected from a group consisting of Pluronic F68, Pluronic F127, Pluronic P105 and Pluornic L44.

5. The method according to claim 2, wherein an amount of pores contained in the melamine-formaldehyde sphere is increased when a temperature for carbonization is higher during carbonizing the melamine-formaldehyde sphere.
